(19) United States
(12) Patent Application Publication
(10) Pub. No.: US 2008/0175244 A1
(43) Pub. Date: Jul. 24, 2008

(54) METHOD AND APPARATUS HAVING A HYBRID ROUTING ARCHITECTURE WITH A COMBINATION OF NETWORK LAYER REACTIVE ROUTING AND SUBNET LAYER PROACTIVE ROUTING

(75) Inventors: Suresh K. Iyer, Germantown, MD (US); Craig A. Schweinhart, Rockville, MD (US)

Correspondence Address: PRASS & IRVING, LLP, 2661 Riva Road, Bldg. 1000, Suite 1044, ANNAPOLIS, MD, 21401, US

(73) Assignee: Lockheed Martin Corporation

(21) Appl. No.: 11/626,749

(22) Filed: Jan. 24, 2007

(51) Int. Cl. H04L 12/56

(52) U.S. Cl. 370/392; 370/469

(57) ABSTRACT

A method and apparatus that sends packets from a wireless communication device is disclosed. The method may include receiving a packet for transmission to a destination at the network layer from an upper layer within wireless communication device, determining if the packet's route to the destination can be determined within the network layer, wherein if the packet route to the destination can be determined within the layer, forwarding the packet to the destination, otherwise querying a subnet layer for the packet's route to the destination and determining if the subnet layer has determined the packet's route to the destination, wherein if the subnet layer has determined the packet's route to the destination, forwarding the packet to the subnet layer for forwarding to destination, otherwise sending a route request to the destination, receiving response to the route request from the destination, and forwarding the packet according to route specified in the route request response.

### BACKGROUND OF THE INVENTION

1. Field of the Invention

The invention relates to wireless devices, and in particular, to communication routing architectures used by wireless devices.

2. Introduction

Routing in Mobile Ad Hoc Networks requires routing architectures which can adapt to fast changing links and consume minimal bandwidth. A wireless network can be comprised of multiple sub-networks with different characteristics and using a different “waveform.” Here the waveform is defined as a combination of layers 1, 2, and 2.5 of the Open Systems Interconnection (OSI) reference protocol stack which correspond to physical, data link and sub-network layers respectively.

Traditional routing architectures for mobile ad hoc networks with a proactive or reactive routing protocol running at the network layer do not meet requirements for dense, highly mobile Networks. The overhead and latency introduced by the network layer routing protocol does not meet the threshold requirements of the networks defined for different waveforms. For military and civilian networks with Software Defined Radios (SDRs), some waveforms provide for subnet layer routing but do not provide complete network connectivity in networks with nodes running different waveforms at layer ½ and spanning multiple subnets. Such networks are also non-interoperable with other networks running a different waveform. A solution which provides the ability to route packets optimally in heterogeneous networks is essential for such networks.

### SUMMARY OF THE INVENTION

A method and apparatus that sends packets from a wireless communication device is disclosed. The method may include receiving a packet for transmission to a destination at the network layer from an upper layer within wireless communication device, determining if the packet's route to the destination can be determined within the network layer, wherein if the packet route to the destination can be determined within the layer, forwarding the packet to the destination, otherwise querying a subnet layer for the packet's route to the destination and determining if the subnet layer has determined the packet's route to the destination, wherein if the subnet layer has determined the packet's route to the destination, forwarding the packet to the subnet layer for forwarding to destination, otherwise sending a route request to the destination, receiving response to the route request from the destination, and forwarding the packet according to route specified in the route request response.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary diagram of packet routing environment in accordance with a possible embodiment of the invention;

FIG. 2 illustrates a block diagram of an exemplary wireless device in accordance with a possible embodiment of the invention;

FIG. 3 is an exemplary flowchart illustrating one possible packet sending process in accordance with one possible embodiment of the invention; and

FIG. 4 is an exemplary flowchart illustrating one possible packet forwarding process in accordance with one possible embodiment of the invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The invention comprises a variety of embodiments, such as a method and apparatus and other embodiments that relate to the basic concepts of the invention.

This invention concerns a multi-layered approach to packet processing in a network. In addition to the sub-network layer proactive routing process associated with the waveform which routes using hardware addresses for each subnet, the network provides a network layer reactive routing process which discovers routes only when the subnet layer does not have a route to the destination. This process eliminates unnecessary overhead of running a table driven protocol at the network layer. It also provides reachability across heterogeneous networks running different subnet layer routing process but the same network layer reactive routing process.

This is a major improvement over other suggested multi-layered routing architectures like Wideband networking waveform (WNW) used in JTRS cluster-1. WNW uses a proprietary variant of OSPF for network layer routing, which being a table driven protocol, adds its own significant overhead to the network.

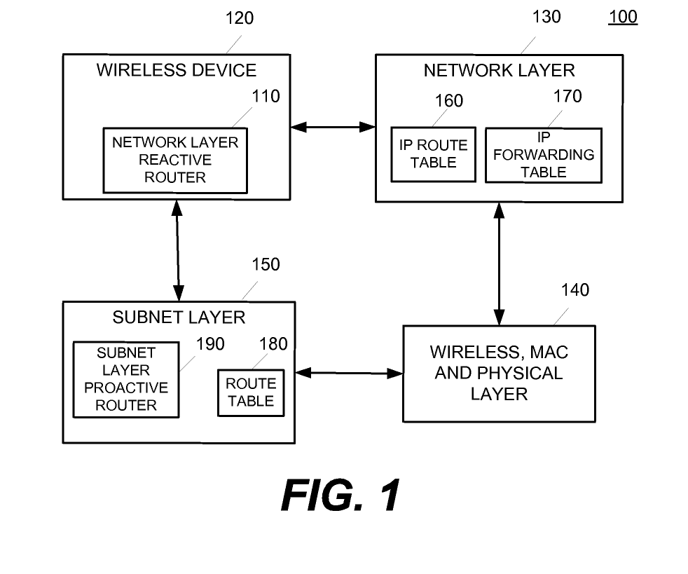

FIG. 1 illustrates an exemplary diagram of a packet routing environment 100 in accordance with a possible embodiment of the invention. In particular, the packet routing environment 100 may include a network layer reactive router 110 that may be included in a wireless communication device 120, a network layer 130, a subnet layer 150, and a wireless, MAC and physical layer 140. The network layer 130 may include an IP route table 160 and an IP forwarding table 170. The sub-network (“subnet”) layer 150 may include a subnet layer proactive router 190 and a route table 180.

A defined interface between the subnet layer proactive router 190 and the network layer reactive router 110 may be required for optimum performance.

The subnet layer proactive router 190 proactively maintains all reachable routes within a given waveform network. This process is designed to meet the specific requirements of the waveform. These requirements could be in the form of density of the network or in terms or in terms of packet forwarding requirements, such as desirable latency.

The network layer reactive router 110 discovers routes on-demand for packet forwarding. This process is performed by sending a route request and receiving a route reply from the destination only when there are no routes available from the subnet layer. Hence, the process is most likely to be used for inter-waveform network communication but it can also be used inside a given waveform network when the subnet layer proactive router 190 still has not converged.

The wireless communication device 120 may be a mobile telephone, a cellular telephone, a wireless radio, a portable computer, a laptop, an MP3 player, a satellite radio, or a satellite television, for example.

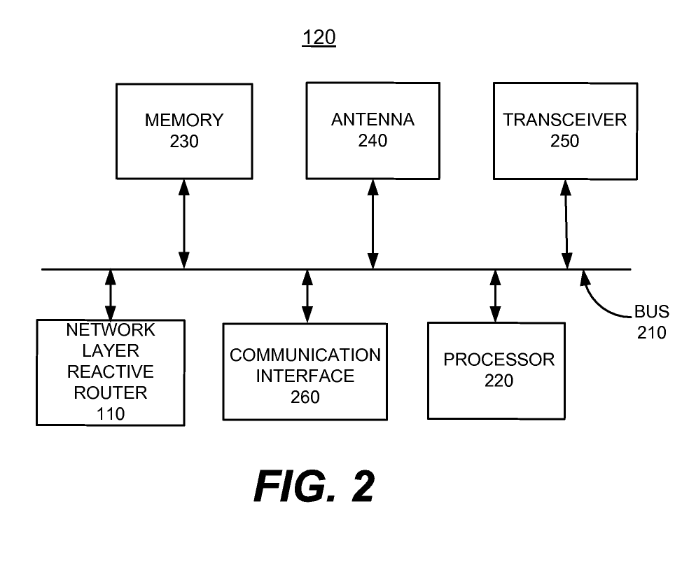

FIG. 2 shows a more detailed exemplary block diagram of the exemplary wireless communication device 120 having a network layer reactive router 110 in accordance with a possible embodiment of the invention. The exemplary mobile communication device 120 may include a bus 210, a processor 220, a memory 230, an antenna 240, a transceiver 250, a communication interface 260, voice search engine 270, and a network layer reactive router 110. Bus 210 may permit communication among the components of the wireless communication device 120.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220.

Transceiver 250 may include one or more transmitters and receivers. The transceiver 250 may include sufficient functionality to interface with any network or communication station and may be defined by hardware or software in any manner known to one of skill in the art. The processor 220 is cooperatively operable with the transceiver 250 to support operations within the communication network.

Communication interface 260 may include any mechanism that facilitates communication via the communication network. For example, communication interface 260 may include a modem. Alternatively, communication interface 260 may include other mechanisms for assisting the transceiver 250 in communicating with other devices and/or systems via wireless connections.

The wireless communication device 120 may perform such functions in response to processor 220 by executing sequences of instructions contained in a computer-readable medium, such as, for example, memory 230. Such instructions may be read into memory 230 from another computer-readable medium, such as a storage device or from a separate device via communication interface 260.

The wireless communication device 120 illustrated in FIGS. 1 and 2 and the related discussion are intended to provide a brief, general description of a suitable communication and processing environment in which the invention may be implemented. Although not required, the invention will be described, at least in part, in the general context of computer-executable instructions, such as program modules, being executed by the wireless communication device 120, such as a communication server, or general purpose computer. Generally, program modules include routine programs, objects, components, data structures, etc. that perform particular tasks or implement particular abstract data types. Moreover, those skilled in the art will appreciate that other embodiments of the invention may be practiced in communication network environments with many types of communication equipment and computer system configurations, including cellular devices, mobile communication devices, personal computers, hand-held devices, multi-processor systems, microprocessor-based or programmable consumer electronics, and the like.

For illustrative purposes, the operation of the network layer reactive router 110 and the network layer reactive routing process will be described below in relation to the block diagrams shown in FIGS. 1 and 2.

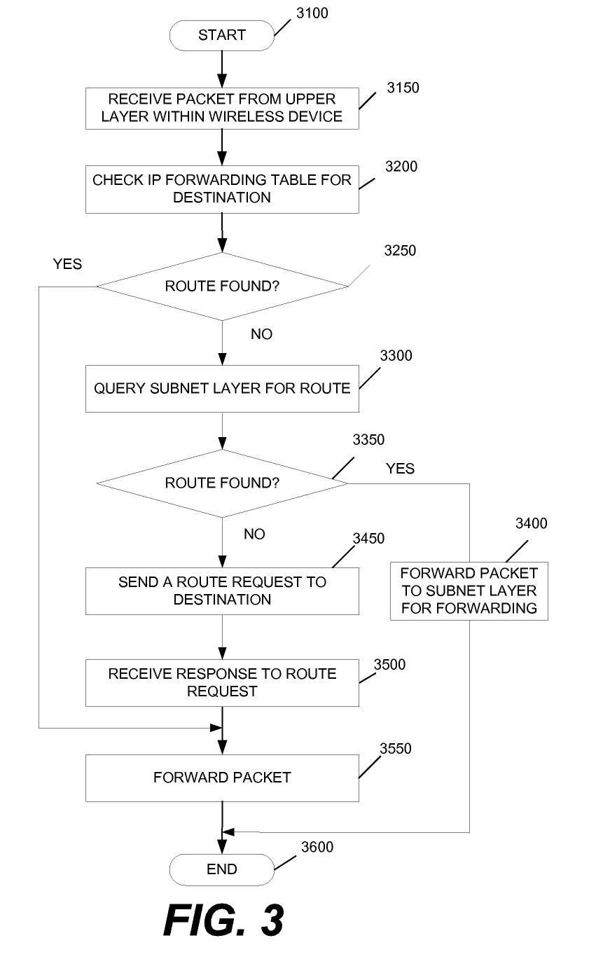

FIG. 3 is an exemplary flowchart illustrating one possible packet sending process in accordance with one possible embodiment of the invention. The process begins in step 3100, and proceeds to step 3150 in which the network layer reactive router 110 receives a packet from an upper layer within the wireless communication device 120. At step 3200, the network layer reactive router 110 checks the IP forwarding table 170 for the packet's destination. At step 3250, the network layer reactive router 110 determines whether the IP forwarding table 170 the packet's destination has been found. If the network layer reactive router 110 finds the packet's destination, the process goes to step 3550 and the network layer routing reactive router 110 forwards the packet to the destination. The process then goes to step 3600 into and ends.

If at step 3250, the network layer reactive router 110 does not find the route for the packet in the IP forwarding table 170, at step 3300, the network layer reactive router 110 queries the subnet layer 150 for the packet route. At step 3350, if the network layer reactive router 110 determines if a message from the subnet layer 150 has been received with the packet route.

If the network layer reactive router 110 receives a message from the subnet layer protocol that the packet route has been found, at step 3400, the network layer reactive router 110 forwards the packet to the subnet layer 150 for forwarding. The process then goes to step 3600 into and ends.

If at step 3350, the network layer reactive router 110 determines that a packet route has not been found, then at the step 3450, the network layer reactive router 110 sends a route request to the packet destination. At step 3500, the network layer reactive router 110 receives a response to the route request from the destination. At step 3550, the network layer reactive router 110 forwards the packet to the destination according to the received route. The process then goes to step 3600 and ends.

Thus, the network reactive router 110 will first query the lower layer forwarding for a route. If there is a positive response from the lower layer, the network reactive router 110 will call an API function to route the packet at the lower layer. If the response is negative, it will use the network layer IP route table 160 and call a different API function to just forward the packet to the specified next hop.

This approach is especially useful in using the network reactive routing process approach as described herein. If there is a lower layer route, the upper layer does not have to initiate a route request and thus removing the latency for reactively finding a route. The routing information provided by the subnet layer 150 will use MAC addresses. These MAC addresses have to be converted to IP addresses for use by the network reactive router 110. This conversion function will create IP address from MAC address using the prefix for the wireless interface.

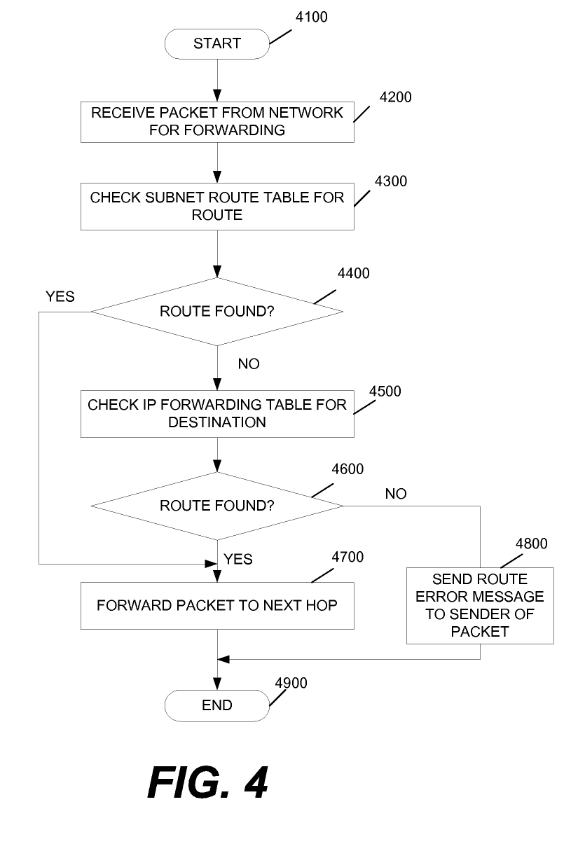

FIG. 4 is an exemplary flowchart illustrating some of the basic steps associated with a packet forwarding process in accordance with a possible embodiment of the invention. The process begins at step 4100 and continues to step 4200, in which the network layer reactive router 110 receives a packet from the network for forwarding. At step 4300, the network layer reactive router 110 checks the subnet layer 150 route table 180 for the route. At step 4400, the network layer reactive router 110 determines whether a route has been found. If the route has been found, the process goes to step 4700 and the network layer reactive router 110 forwards the packet to the next hop. The process then goes to step 4900 and ends.

If at step 4400, a route is not found, the process goes step 4500 and the network layer reactive router 110 checks the IP forwarding table 170 for a destination. At step 4600, the network layer reactive router 110 determines whether a route has been found. If a route has been found, at step 4700, the network layer reactive router 110 forwards the packet to the next hop. The process then goes to step 4900 and ends.

If at step 4600, the network layer reactive router 110 determines that a route has not been found, then at step 4800, the network layer reactive router 110 sends a route error message to the sender of the packet. The process then goes to step 4900 and ends.

This the network layer reactive routing process provides layered routing to connect heterogeneous networks without using proprietary protocols. It imposes minimal overhead on the network resources by using a reactive process at network layer. This is a major improvement over other conventional suggested routing architectures which use a proactive routing process for network layer 130 routing. These conventional architectures are table driven protocols which add their own significant overhead to the network.

Because of the sub-network interconnectivity provided by the lower layers, the network layer reactive router 110 does not have to keep a topology for the whole subnet layer 150. In fact, the network layer reactive routing process imparts less overhead on the network than if the network layer reactive router 110 maintained the topology proactively.

The network layer reactive router 110 which can find routes as they are needed will provide a scalable routing function in the network. The latency aspect of the network layer reactive process will not impact the ability to satisfy latency requirements in the network as it will be used in conjunction with the proactive routing process at the MANET layer.

The network layer reactive routing process allows waveforms to be designed to solve a particular set of requirements and still provide interoperability with other waveform networks. This is done by allowing the waveform design to incorporate a subnet layer proactive routing process unique for that network. That subnet layer proactive routing process must serve to support a few standard interfaces to be integrated into the network layer reactive routing architecture.

As stated above, the network layer reactive routing process may require a defined interface between the subnet layer router 190 and the network layer reactive router 110 for optimum performance. It also allows a single instance of the network layer reactive router to support multiple waveforms on a single wireless communications device 120. Each of these waveforms may use a different network interface. The network layer reactive router 110 may provide connectivity across all these different waveforms.

The network layer reactive routing process may also provide for a common management solution for routing configuration. Another advantage of this approach is the ability to support different quality of path metrics in routing. Since the network layer reactive routing process may discover the routes on-demand, the network layer reactive router can be tuned to select paths based on different criteria for each kind of application. This can be achieved by having a mapping table reconfigured inside the wireless communication device 120.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the network layer reactive router 110 in FIGS. 1 and 2 each processing the content in various possible ways. It does not necessarily need to be one system used by all end users. Accordingly, the appended claims and their legal equivalents should only define the invention, rather than any specific examples given.

We claim:

1. A method for sending packets from a wireless communication device, comprising:
receiving a packet for transmission to a destination at the network layer from an upper layer within wireless communication device;
determining if the packet's route to the destination can be determined within the network layer, wherein if the packet route to the destination can be determined within the layer,
forwarding the packet to the destination, otherwise querying a subnet layer for the packet's route to the destination;
determining if the subnet layer has determined the packet's route to the destination, wherein if the subnet layer has determined the packet's route to the destination,
forwarding the packet to the subnet layer for forwarding to destination, otherwise sending a route request to the destination;
receiving response to the route request from the destination; and
forwarding the packet according to route specified in the route request response.

2. The method of claim 1, wherein the packet's route to the destination is determined by checking an Internet Protocol (IP) forwarding table.

3. The method of claim 1, further comprising:
defining an interface between the network layer and the subnet layer.

4. The method of claim 1, further comprising:
supporting multiple waveforms, wherein each of the multiple waveforms uses a different network interface; and
providing connectivity across the multiple waveforms.

5. The method of claim 1, wherein the wireless communication device is one of a mobile telephone, a cellular telephone, a wireless radio, a portable computer, a laptop, an MP3 player, a satellite radio, and a satellite television.

6. An apparatus that sends packets from a wireless communication device, comprising:
an interface between a network layer and a subnet layer; and
a network layer reactive router that receives a packet for transmission to a destination at the network layer from an upper layer within wireless communication device, determines if the packet's route to the destination can be determined within the network layer, wherein if the packet route to the destination can be determined within the layer, the network layer reactive router forwards the packet to the destination, otherwise the network layer reactive router queries a subnet layer for the packet's route to the destination and determines if the subnet layer has determined the packet's route to the destination, wherein if the subnet layer has determined the packet's route to the destination, the network layer reactive router forwards the packet to the subnet layer for forwarding to destination, otherwise the network layer reactive router sends a route request to the destination, receives a response to the route request from the destination, and forwards the packet according to route specified in the route request response.

7. The apparatus of claim 6, wherein the network layer reactive router determines the packet's route to the destination by checking an Internet Protocol (IP) forwarding table.

8. The apparatus of claim 6, wherein the network layer reactive router defines the interface between the network layer and the subnet layer.

9. The apparatus of claim 6, wherein the network layer reactive router supports multiple waveforms, and provides connectivity across the multiple waveforms, wherein each of the multiple waveforms uses a different network interface.

10. The apparatus of claim 6, wherein the wireless communication device is one of a mobile telephone, a cellular telephone, a wireless radio, a portable computer, a laptop, an MP3 player, a satellite radio, and a satellite television.

11. A method for forwarding packets from a wireless communication device, comprising:
receiving a packet from a network for forwarding to a next hop;
determining if the packet's route is found in a subnet route table, wherein if the packet's route is found in the subnet route table,
forwarding the packet to the next hop according to the subnet route table, otherwise,
determining if the packet's route to the next hop can be determined within the network layer, wherein if the packet route to the destination can be determined within the network layer,
forwarding the packet to the next hop, otherwise, sending a route error message to the sender of the packet.

12. The method of claim 11, wherein the packet's route to the next hop is determined by checking an Internet Protocol (IP) forwarding table.

13. The method of claim 11, further comprising:
defining an interface between the network layer and the subnet layer.

14. The method of claim 11, further comprising:
supporting multiple waveforms, wherein each of the multiple waveforms uses a different network interface; and
providing connectivity across the multiple waveforms.

15. The method of claim 11, wherein the wireless communication device is one of a mobile telephone, a cellular telephone, a wireless radio, a portable computer, a laptop, an MP3 player, a satellite radio, and a satellite television.

16. An apparatus that sends packets from a wireless communication device, comprising:
an interface between a network layer and a subnet layer; and
a network layer reactive router that receives a packet from a network for forwarding to a next hop, determines if the packet's route is found in a subnet route table, wherein if the network layer reactive router finds the packet's route in the subnet route table, the network layer reactive router forwards the packet to the next hop according to the subnet route table, otherwise, network layer reactive router determines if the packet's route to the next hop can be determined within the network layer, wherein if the network layer reactive router can determine the packet's route to the next hop within the network layer, the network layer reactive router forwards the packet to the next hop, otherwise, the network layer reactive router sends a route error message to the sender of the packet.

17. The apparatus of claim 16, wherein the network layer reactive router determines the packet's route to the next hop by checking an Internet Protocol (IP) forwarding table.

18. The apparatus of claim 16, wherein the network layer reactive router defines the interface between the network layer and the subnet layer.

19. The apparatus of claim 16, wherein the network layer reactive router supports multiple waveforms, and provides connectivity across the multiple waveforms, wherein each of the multiple waveforms uses a different network interface.

20. The apparatus of claim 16, wherein the wireless communication device is one of a mobile telephone, a cellular telephone, a wireless radio, a portable computer, a laptop, an MP3 player, a satellite radio, and a satellite television.
